(19) United States
(12) Patent Application Publication
(10) Pub. No.: US 2004/0218511 A1
(43) Pub. Date: Nov. 4, 2004

(54) Optical disk having a hard coat layer having lubricity imparted, and process for its production

(75) Inventors: Satoshi Kondo, Yokohama-shi (JP); Nobuyuki Tamai, Tokyo (JP); Hirotsugu Yamamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, TOKYO (JP)

(21) Appl. No.: 10/860,499

(22) Filed: Jun. 4, 2004

Related U.S. Application Data
(63) Continuation of application No. PCT/JP02/12820, filed on Dec. 6, 2002.

(30) Foreign Application Priority Data
Dec. 7, 2001 (JP) 2001-374579
Dec. 17, 2001 (JP) 2001-383200
Dec. 26, 2001 (JP) 2001-393245

(51) Int. Cl. G11B 7/24

(52) U.S. Cl. 369/288; 369/94; 369/283

(57) ABSTRACT

An optical disk of a system wherein a recording layer is irradiated through a thin film cover layer with a laser beam having a short wavelength, such as a blue laser beam, and the optical disk has a hard coat layer excellent in abrasion resistance, durability of the surface lubricity and transparency.

On the surface of the recording layer of the optical disk, a hard coat layer is formed via the thin film cover layer, said hard coat layer being made of a transparent cured product layer of an active energy ray curable composition which comprises a polyfunctional compound having at least two polymerizable functional groups polymerizable by an active energy ray, a modified colloidal silica having an average particle size of from 1 to 200 nm and having the surface modified with a mercapto silane compound, a lubricity-imparting agent having a radical polymerizable functional group in its molecule, and a photopolymerization initiator.

### BACKGROUND OF THE INVENTION

1. Field of the Invention

The present invention relates to an optical disk of a system wherein a recording layer is irradiated through a thin film cover layer with a light to be used for recording and/or retrieving, wherein a hard coat layer excellent in abrasion resistance, durability of the surface lubricity, transparency, etc., is formed via the thin film cover layer on the surface of the recording layer.

2. Discussion of Background

In recent years, attention has been drawn to an optical recording device capable of recording a large amount of data in high density and capable of quickly retrieving the recorded information, in response to the progress in multimedia. Such an optical recording device includes one for playing a read-only disk having information preliminarily stamped on a disk at the time of preparation of the disk to permit only to retrieve the information, such as CD or a laser disk, one for recording/playing a recordable disk capable of recording only once, such as CD-R, and one for recording/playing a rewritable disk capable of rewriting and erasing data as many times as desired by means of a magneto-optical recording system or a phase change recording system. By these optical recording devices, retrieving/recording of data is carried out by means of a beam spot having a laser beam narrowed down to a diffraction limit by a lens. The size of this beam spot will be about λ/NA where λ is the wavelength of the laser beam, and NA is the numerical aperture of the lens (“Basic and Application of Optical Disk Storage”, compiled by Yoshihito Kakuta, Institute of Electronics, Information and Communication Engineers, 1995, p65).

In order to record information in a higher density i.e. to form a smaller pit pattern on an optical recording medium, it is necessary to make a laser beam spot smaller. In order to reduce the size of the beam spot, two methods are conceivable from the above formula i.e. a method of shortening the laser beam wavelength (λ), or a method of increasing the numerical aperture (NA) of the lens. The wavelength of a semiconductor laser for an optical disk which is commonly used at present, is mainly from 780 to 680 nm, but a study is being made to employ an orange color laser having a shorter wavelength of 650 nm, or a green or blue laser beam having a further shorter wavelength.

Particularly, as a system of employing a blue laser, it has been proposed to obtain a higher recording density by adjusting the wavelength of the light source to a level of 400 nm and NA to at least 0.6. However, the allowance for a tilt i.e. an inclination of the optical disk plane from the right angle to the optical axis and the allowance for non-uniformity in thickness of the optical disk decrease due to shortening of the wavelength of the light source or increase of NA.

The reason for the decrease of such allowances is such that in the case of the tilt of the optical disk, coma aberration occurs, and in the case of the non-uniformity in thickness of the optical disk, spherical aberration occurs, whereby the condensing performance of the optical head device deteriorates, and read out of a signal tends to be difficult.

Therefore, in a conventional compact disk (CD) or the like, the thickness of a cover layer formed on the surface of a recording layer is 1.2 mm, and in a digital versatile disk (DVD) or the like, the thickness of such a cover layer is 0.6 mm, whereby the respective disk substrates themselves have played the role of such cover layers. However, in the system of employing a blue laser, the numerical aperture (NA) of the lens is made large, whereby in order to gain the allowance for the above tilt or the allowance for the non-uniformity in thickness of the optical disk even a little, it is necessary to make this cover layer thin to a level of 0.1 mm, and it has become impossible to use the conventional disk substrate itself as the cover layer. Therefore, it is necessary to form a thin film cover layer on the side of the disk substrate having a laminated film such as a reflective film, a recording film or the like formed (the laminated film may hereinafter sometimes be referred to simply as a recording layer).

When a laser having a short wavelength is used, the distance between the optical head and the optical disk will be small at a level of from 0.1 to 0.2 mm, and in some cases, it may happen that the optical head will be in contact with the optical disk, and the surface of the recording layer of the optical disk is required to have a high scratch resistance.

Further, when a laser having a shorter wavelength is used, scratches formed or dust deposited on a laser beam incident surface of the optical disk is likely to lead to errors at the time of recording or retrieving. Therefore, in order to prevent such errors at the time of recording or retrieving, the thin film cover layer constituting the laser beam incident surface is required to have higher abrasion resistance. Further, it is also effective to reduce an exerted external force by imparting lubricity to the surface of the thin film cover layer. However, in a case where an optical disk is put in a drive for a long time, the disk in the drive will be at least 40° C., whereby a lubricity-imparting agent tends to evaporate to deteriorate the durability.

### SUMMARY OF THE INVENTION

It is an object of the present invention to realize improvement of the performance of an optical disk of a system wherein a recording layer is irradiated through a thin film cover layer with a light to be used for recording and/or retrieving (hereinafter sometimes referred to as an ultrahigh density recording optical disk or simply as an optical disk). Namely, it is an object of the present invention to provide an optical disk having a hard coat layer formed to have abrasion resistance and lubricity excellent in durability, via a thin film cover layer on the surface of the recording layer of the optical disk.

Further, another object of the present invention is to provide an optical disk wherein the thin film cover layer has a high transmittance for a laser beam, has good adhesion to the recording layer and has an extremely small disk deformation due to e.g. shrinkage at the time of forming the thin film cover layer, and a sufficient hard coat performance can be obtained when the specific hard coat layer is formed, and a process for its production.

Namely, the present invention provides an optical disk having a hard coat layer having lubricity imparted, which is an optical disk of a system wherein a recording layer is irradiated through a thin film cover layer with a light to be used for recording and/or retrieving, characterized in that on the surface of the recording layer formed on an optical disk substrate, the following hard coat layer (X) is formed via the thin film cover layer (Z):

Hard coat layer (X): A cured product layer obtained by curing an active energy ray curable composition (Q) which comprises a polyfunctional compound (A) having at least two polymerizable functional groups polymerizable by an active energy ray, a modified colloidal silica (B) having an average particle size of from 1 to 200 nm and having the surface modified with a mercapto silane compound having an organic group having a mercapto group, and a hydrolysable group and/or a hydroxyl group, bonded to a silicon atom, a lubricity-imparting agent (C) having a radical polymerizable functional group in its molecule, and a photopolymerization initiator (D1).

According to the present invention, an active energy curable organic/inorganic hybrid type transparent cured product layer is formed via a thin film cover layer on the surface of a recording layer of an optical disk, whereby it is possible to provide an optical disk having a hard coat layer which is excellent in abrasion resistance and which at the same time has high durability of the surface lubricity, since the lubricity-imparting agent to be used is free from evaporation by heating, as it is copolymerized with the matrix resin at the time of a photocuring reaction of the matrix resin.

Further, the present invention provides an optical disk having a hard coat layer having lubricity imparted, which is an optical disk of a system wherein a recording layer is irradiated through a thin film cover layer with a light to be used for recording and/or retrieving, characterized in that on the surface of the recording layer formed on an optical disk substrate, the following hard coat layer (X′) is formed via the thin film cover layer (Z):

Hard coat layer (X′): A cured product layer obtained by curing a coating composition (Q′) which comprises a polysilazane (H) and a lubricity-imparting agent (C′) having a radical polymerizable functional group in its molecule.

According to the present invention, a very high scratch resistance can be obtained by selecting, as the hard coat layer (X′), a silica cured product derived from a polysilazane compound.

Further, the present invention provides such an optical disk wherein the thin film cover layer (Z) is a cured product layer obtained by curing an active energy ray curable composition (P) which comprises a polyfunctional urethane acrylate compound (E), a compound (F) having at least one active energy ray curable polymerizable functional group having a polycycloalkane structure, and a photopolymerization initiator (D2).

Further, the present invention provides a process for producing an optical disk of a system wherein a recording layer is irradiated through a thin film cover layer with a light to be used for recording and/or retrieving, characterized by forming a non-cured product layer (Z1), a partially cured product layer (Z2) or a cured product layer (Z) of the active energy ray curable composition (P), on the surface of a recording layer formed on an optical disk substrate, forming a non-cured product layer (X1) or a partially cured product layer (X2) of the active energy ray curable composition (Q) or the coating composition (Q′), on the surface of said (Z1), (Z2) or (Z), and then, curing the non-cured product layer (X1) or the partially cured product layer (X2) of said (Q) or (Q′), when the layer of said (P) is the cured product layer (Z), or simultaneously curing the layer of said (P) and the layer of said (Q) or (Q′), when the layer of said (P) is the non-cured product layer (Z1) or the partially cured product layer (Z2), to obtain an optical disk having the thin film cover layer (Z) and the hard coat layer (X) or (X′) formed.

According to the present invention, as a resin for forming the thin film cover layer (Z), a specific urethane acrylate excellent in flexibility and having a low curing shrinkage and a specific polycycloalkane compound having a high T_{g} and a low curing shrinkage, are used in combination, whereby low shrinkage can be accomplished, and when a hard coat layer is formed thereon, a layer capable of exhibiting an excellent hard coat performance, can be formed.

### DETAILED DESCRIPTION OF THE PREFERRED EMBODIMENTS

The optical disk in the present invention is an ultrahigh density recording optical disk which employs a short wavelength laser represented by a blue laser, and accordingly, the optical disk substrate having a recording layer formed thereon, and the thin film cover layer, are separately designed. Thus, the disk in the present invention means all types of optical disks, so long as they are optical disks of a system wherein the recording layer is irradiated through a thin film cover layer with a light to be used for recording and/or retrieving.

The hard coat layer (X) in the present invention is a cured product layer obtained by curing an active energy ray curable composition (Q) which comprises a polyfunctional compound (A) having at least two polymerizable functional groups polymerizable by an active energy ray, a modified colloidal silica (B) having an average particle size of from 1 to 200 nm and having the surface modified with a mercapto silane compound having an organic group having a mercapto group, and a hydrolysable group and/or a hydroxyl group, bonded to a silicon atom (hereinafter sometimes referred to as the modified colloidal silica (B) or simply as (B)), a lubricity-imparting agent (C) having a radical polymerizable functional group in its molecule (hereinafter sometimes referred to as the lubricity-imparting agent (C) or simply as (C)), and a photopolymerization initiator (D) (hereinafter sometimes referred to simply as (D)).

Firstly, the active energy ray curable composition (Q) (hereinafter sometimes referred to simply as the composition (Q)) will be described. The composition (Q) is one disclosed in JP-A-10-81839. In the following description, an acryloyl group and a methacryloyl group will generally be referred to as a (meth)acryloyl group, and the same will apply also to such an expression as a (meth)acryloyloxy group, (meth)acrylic acid or a (meth)acrylate.

In the composition (Q), the polyfunctional compound (A) having at least two polymerizable functional groups polymerizable by an active energy ray (hereinafter sometimes referred to as the compound (A) or simply as (A)) corresponds to the polyfunctional compound (a) disclosed in paragraphs 0013 to 0052 of JP-A-10-81839. As the compound (A) in the present invention, one having at least three polymerizable functional groups in its molecule, wherein the molecular weight per functional group is at most 100, is particularly preferred. Specifically, trimethylol propane tri(meth)acrylate, pentaerithritol tri(meth)acrylate, pentaerithritol tetra(meth)acrylate or dipentaerithritol hexa(meth)acrylate, may, for example, be mentioned.

Next, the modified colloidal silica (B) in the present invention corresponds to the component (B) disclosed in paragraphs 0057 to 0079 of JP-A-10-81839. Further, the mercapto silane compound in the modified colloidal silica (B) is preferably a compound represented by the following formula (1).

HS—R—SiXₙR¹₃₋ₙ (1)

In the formula (1), HS—R is an organic group having a mercapto group, R is a bivalent hydrocarbon group, R¹ is a monovalent hydrocarbon group, X is a hydroxyl group or a hydrolysable group and n is an integer of from 1 to 3.

As the modified colloidal silica (B) in the present invention, one obtained by adding a mercapto silane compound to an organic dispersant having a colloidal silica dispersed therein, followed by hydrolysis, will be particularly preferably employed.

In the composition (Q), the proportions of the compound (A) and the modified colloidal silica (B) are not particularly limited. However, (B) is preferably from 5 to 300 parts by mass, per 100 parts by mass of (A). If the proportion of (B) is too small, no adequate abrasion resistance tends to be obtained, and if the proportion of (B) is too much, a haze is likely to result in the cured coating film, and cracking or the like is likely to form when the disk is forcibly deformed by an external force. The proportions are more preferably such that (B) is from 10 to 200 parts by mass, per 100 parts by mass of (A).

The lubricity-imparting agent (C) in the composition (Q) may be obtained by introducing a radical polymerizable functional group to a silicon-type compound which is commonly used as a lubricity-imparting agent (such as polydimethylsiloxane, a polydimethylsiloxane/polyether block copolymer, an alkyl group-modified polydimethylsiloxane, a fluorinated compound, a fatty acid ester wax such as an esterified product of a polyol compound with a fatty acid). In the present invention, the radical polymerizable functional group may be any group so long as it has a reactivity with an active radical derived from the above-mentioned polymerizable functional group in (A). For example, a (meth)acryl group, an allyl group, a vinyl group, a vinyl ether group or a mercapto group may, for example, be mentioned. As the lubricity-imparting agent (C), polydimethylsiloxane having a mercapto group in its molecule, or polydimethylsiloxane having a (meth)acryl group in its molecule, may, for example, be particularly preferred.

Such a lubricity-imparting agent (C) having a radical polymerizable functional group, is reacted with the compound (A) during the irradiation with an active energy ray to cure the composition (Q), and, as is different from a non-reactive lubricant, will not be wiped off during use for a long time. Thus, the hard coat layer (X) having lubricity imparted, can maintain excellent surface lubricity over a long period of time.

In the present invention, the number average molecular weight of the lubricity-imparting agent (C) is preferably at least 1000. If the number average molecular weight is less than 1000, no adequate lubricity tends to be obtainable.

The proportions of the compound (A) and the lubricity-imparting agent (C) in the composition (Q) are not particularly limited, but it is preferred that (C) is from 0.01 to 10 parts by mass per 100 parts by mass of (A). If the proportion of (C) is too small, the obtainable lubricity tends to be not adequate, and if the proportion of (C) is too much, the hard coat layer (X) itself will be plasticized, whereby the abrasion resistance tends to decrease.

As the photopolymerization initiator (D1) in the composition (Q), a known or well-known initiator may be employed. A readily available commercial product is particularly preferred. Further, a plurality of photopolymerization initiators may be used in combination.

Specifically, the photopolymerization initiator (D1) may, for example, be an aryl ketone type photopolymerization initiator (such as an acetophenone, a benzophenone, an alkylaminobenzophenone, a benzoyl, a benzoin, a benzoin ether, a benzyldimethyl ketal, a benzoin benzoate, or an α-acyloxime ester), a sulfur-containing photopolymerization initiator (such as a sulfide or a thioxanthone), an acylphosphine oxide type photopolymerization initiator, a diacylphosphine oxide type photopolymerization initiator, or other photopolymerization initiators. Further, the photopolymerization initiator (D1) may be used in combination with a photosensitizer such as an amine.

The following compounds may, for example, be mentioned as the photopolymerization initiator (D1).

4-phenoxydichloroacetophenone, 4-tert-butyldichloroacetophenone, 4-tert-butyltrichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-methylpropan-1-one, 1-(4-(2-hydroxyethoxy)phenyl)-2-hydroxy-2-methylpropan-1-one, 1-hydroxycyclohexylphenylketone and 2-methyl-1-{4-(methylthio)phenyl}-2-morpholinopropan-1-one.

Benzoin, benzoin methyl ether, benzoin ethyl ether, benzoin isopropyl ether, benzoin isobutyl ether, benzyl dimethyl ketal, benzophenone, benzoyl benzoate, benzoylmethyl benzoate, 4-phenylbenzophenone, hydroxybenzophenone, benzophenone acrylate, 3,3′-dimethyl-4-methoxybenzophenone, 3,3′,4,4′-tetrakis(tert-butylperoxycarbonyl)benzophenone, 9,10-phenanthrenequinone, camphoroquinone, dibenzosuberone, 2-ethylanthraquinone, 4,4′-diethylisophthalophenone, 1-phenyl-1,2-propanedione-2(O-ethoxycarbonyl)oxime, and methylphenyl glyoxylate.

4-benzoyl-4′-methyldiphenyl sulfide, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone.

2,4,6-trimethylbenzoyldiphenylphosphine oxide, benzoyldiphenylphosphine oxide, 2,6-dimethylbenzoyldiphenylphosphine oxide, and bis(2,6-dimethoxybenzoyl)-2,4,4-trimethylpentylphosphine oxide.

The proportion of the photopolymerization initiator (D1) in the composition (Q) is not particularly limited. However, it is usually preferred that the photopolymerization initiator (D1) is from 0.01 to 20 parts by mass, particularly preferably from 0.1 to 10 parts by mass, per 100 parts by mass of the compound (A).

In the present invention, the composition (Q) particularly preferably comprises 100 parts by mass of (A), from 5 to 300 parts by mass of (B), from 0.01 to 10 parts by mass of (C), and from 0.1 to 20 parts by mass of (D1).

The composition (Q) in the present invention may contain the following mono-functional active energy ray curable compound (G) having one polymerizable functional group (hereinafter sometimes referred to also as the mono-functional compound (G) or simply as (G)) or the like, in addition to the compound (A), the modified colloidal silica (B), the lubricity-imparting agent (C) and the photopolymerization initiator (D1). Such a mono-functional compound (G) is preferably a compound having a (meth)acryloyl group, particularly a compound having an acryloyl group. Further, such a mono-functional compound (G) may further have a functional group such as a hydroxyl group or an epoxy group. The proportion of such a mono-functional compound (G) is not particularly limited, but it is usually optionally selected within a range of from 0 to 50 parts by mass per 100 parts by mass of the compound (A).

An alkyl (meth)acrylate represented by the formula CH₂═C(R²)COOCₙH₂ₙ₊₁ (wherein R² is a hydrogen atom or a methyl group, and n is an integer of from 1 to 13) (in the above formula, CₙH₂ₙ₊₁ may be of a linear structure or a branched structure), allyl (meth)acrylate, benzyl (meth)acrylate, butoxyethyl (meth)acrylate, butanediol (meth)acrylate, butoxytriethylene glycol mono(meth)acrylate, tert-butylaminoethyl (meth)acrylate, 3-chloro-2-hydroxypropyl (meth)acrylate, 2-cyanoethyl (meth)acrylate, cyclohexyl (meth)acrylate, 2,3-dibromopropyl (meth)acrylate, dicyclopentenyl (meth)acrylate, N,N-diethylaminoethyl (meth)acrylate, N,N-dimethylaminoethyl (meth)acrylate, 2-ethoxyethyl (meth)acrylate, 2-(2-ethoxyethoxy)ethyl (meth)acrylate, 2-ethylhexyl (meth)acrylate, glycerol (meth)acrylate, glycidyl (meth)acrylate, heptadecafluorodecyl (meth)acrylate, 2-hydroxyethyl (meth)acrylate, 2-hydroxy-3-(meth)acryloyloxypropyltrimethyl ammonium chloride, 2-hydroxypropyl (meth)acrylate, γ-(meth)acryloxypropyltrimethoxysilane, 2-methoxyethyl (meth)acrylate, methoxydiethylene glycol (meth)acrylate, methoxytriethylene glycol (meth)acrylate, methoxytetraethylene glycol (meth)acrylate, methoxydipropylene glycol (meth)acrylate, methoxylated cyclodecatriene (meth)acrylate, morpholine (meth)acrylate, nonylphenoxypolyethylene glycol (meth)acrylate, nonylphenoxypolypropylene glycol (meth)acrylate, octafluoropentyl (meth)acrylate, phenoxyhydroxypropyl (meth)acrylate, phenoxyethyl (meth)acrylate, phenoxydiethylene glycol (meth)acrylate, phenoxytetraethylene glycol (meth)acrylate, phenoxyhexaethylene glycol (meth)acrylate, phenoxy (meth)acrylate, polypropylene glycol (meth)acrylate, 2-sodium sulfonate ethoxy (meth)acrylate, tetrafluoropropyl (meth)acrylate, tetrahydrofurfuryl (meth)acrylate, trifluoroethyl (meth)acrylate, vinyl acetate, N-vinyl caprolactam, N-vinyl pyrrolidone, and dicyclopentadienyl (meth)acrylate.

When the mono-functional compound (G) is used, the proportion of the mono-functional compound (G) based on the total amount of the compound (A) and the mono-functional compound (G) in the composition (A), is not particularly limited.

In the present invention, in the above composition (Q), the following solvent and various other functional compounding agents may be incorporated in addition to the above-described basic components.

In a case where a solvent is used in the composition (Q), it is preferred to use a solvent capable of dissolving the above-described basic components. Further, it is preferred to selectively use a proper solvent depending upon the type of the optical disk substrate. For example, a hydrocarbon, a halogenated hydrocarbon, a ketone, an ether or an ester may, for example, be mentioned as a preferred solvent. Further, the amount of the solvent may optionally be changed depending upon the conditions such as the required viscosity of the composition (Q), the desired thickness of the cured product layer, the drying temperature, etc. Such a solvent in the present invention is preferably used within a range of at most 100 times, preferably from 0.1 to 50 times, by mass, to the total of the compound (A) and the mono-functional compound (G).

As the above-mentioned other functional compounding agents, one or more functional compounding agents may be mentioned which are selected from the group consisting of an ultraviolet absorber, a photostabilizer, an antioxidant, a thermal polymerization preventing agent, a leveling agent, a defoaming agent, a thickener, a sedimentation-preventing agent, a pigment (an organic coloring pigment, or an inorganic pigment), a coloring dye, an infrared absorber, a fluorescent brightener, an antifouling property-imparting agent, a finger print removal property-imparting agent, electroconductive fine particles, an antistatic agent, an anti-fogging agent, a curing catalyst and a coupling agent.

As the ultraviolet absorber, a benzotriazole type ultraviolet absorber, a benzophenone type ultraviolet absorber, a salicylic acid type ultraviolet absorber or a phenyltriazine type ultraviolet absorber, which is commonly used as an ultraviolet absorber for a synthetic resin, is, for example, preferred. Specifically, the compounds disclosed in paragraph 0078 in JP-A-11-268196 may be mentioned. In the present invention, the composition (Q) contains a polyfunctional compound, whereby one having a photopolymerizable functional group in its molecule, such as 2-{2-hydroxy-5-(2-acryloyloxyethyl)phenyl}benzotriazole or 2-hydroxy-3-methacryloyloxypropyl-3-(3-benzotriazole-4-hydroxy-5-tert-butylphenyl)propionate, is particularly preferred.

As the photostabilizer, a hindered amine type photostabilizer which is commonly used as a photostabilizer for a synthetic resin, is preferred. Specifically, the compounds as disclosed in paragraph 0080 in JP-A-11-268196 may be mentioned. In the present invention, one having a polymerizable functional group in its molecule, such as N-methyl-4-metacryloyloxy-2,2,6,6-tetramethylpiperidine, is particularly preferred.

As the antioxidant, a hindered phenol type antioxidant such as 2,6-di-tert-butyl-p-cresol, or a phosphorus type antioxidant such as triphenylphosphite, may, for example, be mentioned. Further, as the leveling agent, a silicon resin type leveling agent, or an acryl resin type leveling agent may, for example, be mentioned.

As the defoaming agent, a silicon resin type defoaming agent such as polydimethylsiloxane may, for example, be mentioned. Further, as a thickener, a polymethyl methacrylate type polymer, a hydrogenated caster oil type compound or a fatty acid amide type compound may, for example, be mentioned.

As the organic coloring pigment, a condensed polycyclic organic pigment, or a phthalocyanine type organic pigment may, for example, be mentioned. As the inorganic pigment, titanium dioxide, cobalt oxide, molybdenum red or titan black may, for example, be mentioned. Further, as the coloring dye, an organic solvent-soluble azo type metal complex salt dye or an organic solvent-soluble phthalocyanine type dye may, for example, be mentioned.

As the infrared absorber, a polymethine type, phthalocyanine type, metal complex type, aminium type, diimonium type, anthraquinone type, dithiol metal complex type, naphthoquinone type, indole phenol type, azo type or triarylmethane type compound may, for example, be mentioned.

As the antifouling property-imparting agent or the finger print removal property-imparting agent, a silicon resin type antifouling additive or a fluorine resin type antifouling additive may, for example, be mentioned.

As the electroconductive fine particles, a metal powder of zinc, aluminum, nickel, etc., iron phosphide, or antimony doped tin oxide, may, for example, be mentioned.

As the antistatic agent, a nonionic antistatic agent, a cationic antistatic agent or an anionic antistatic agent may, for example, be mentioned.

As the curing catalyst, a curing catalyst selected from acids, alkalis or salts may be mentioned.

As the coupling agent, a silane coupling agent or a titanate coupling agent may, for example, be mentioned.

In the present invention, the thickness of the hard coat layer (X) is preferably from 0.1 to 20 μm, particularly preferably from 0.5 to 10 μm. If the thickness of the hard coat layer (X) is too thick, not only no further improvement in the surface property such as abrasion resistance can be expected, but also the layer tends to be brittle, and cracking tends to form in the hard coat layer (X) even by a slight deformation of the disk. On the other hand, if it is too thin, no adequate abrasion resistance of the hard coat layer (X) may be obtainable.

In the present invention, the hard coat layer (X′) is a cured product layer obtained by curing a coating composition (Q′) which comprises a polysilazane (H) and a lubricity-imparting agent (C′) having a radical polymerizable functional group in its molecule. As the polysilazane (H) in the composition (Q′), it is preferred to employ polysilazanes as disclosed in paragraphs 0098 to 0112 in JP-A-11-240103 (which corresponds to U.S. Pat. No. 6,383,641).

Specifically, the polysilazane (H) is a polymer having at least two units of (—Si—N—), and in this chemical formula, a hydrogen atom or an organic group (such as an alkyl group) is bonded to each of the remaining two bonds of the silicon atom (tetravalent) and the remaining one bond of the nitrogen atom (trivalent). Further, it may not only be a polymer of a linear structure composed solely of the above repeating units, but also one wherein one or both of the remaining two bonds of the above silicon atom and one bond of the above nitrogen atom may be bonded to form a cyclic structure. The polymer may be composed solely of repeating units of a cyclic structure, or may be a linear polymer partially having a cyclic structure.

With respect to such polysilazanes (H), polysilazanes as disclosed in e.g. JP-A-9-31333 (which corresponds to U.S. Pat. No. 5,922,411) or in the references cited therein, are available, and such polysilazanes may be used as the polysilazane (H) in the present invention. Further, modified polysilazanes as disclosed in JP-A-9-31333 or in the references cited therein, may also be used as the polysilazane (H) in the present invention.

The polysilazane (H) is decomposed in the presence of oxygen, and silica will be formed by substitution of the nitrogen atom by an oxygen atom. The silica formed from the polysilazane (H) is denser than the silica formed from a hydrolysable silane compound. For example, silica formed from perhydropolysilazane is dense as compared with silica formed from a tetra-functional hydrolysable silane compound (such as a tetraalkoxysilane) and excellent in the surface property such as abrasion resistance.

As the polysilazane (H), a polysilazane containing substantially no organic group (i.e. a perhydropolysilazane), a polysilazane having a hydrolysable group such as an alkoxy group bonded to the silicon atom, or a polysilazane having an organic group such as an alkyl group bonded to the silicon atom or the nitrogen atom, may, for example, be available. In a case of such a polysilazane wherein the silicon atom has a hydrolysable group, a silica containing substantially no organic group will be formed by a hydrolytic reaction at the time of curing. A perhydropolysilazane is particularly preferred from the viewpoint of the low baking temperature and the denseness of the cured coating film after the baking.

As a solvent for dissolving the polysilazane (H) to be used for the coating composition (Q′), it is possible to use a hydrocarbon solvent such as an aliphatic hydrocarbon, an alicyclic hydrocarbon or an aromatic hydrocarbon, a halogenated hydrocarbon solvent, or an ether such as an aliphatic ether or an alicyclic ether.

Specifically, it may, for example, be a hydrocarbon such as pentane, hexane, isohexane, methylpentane, heptane, isoheptane, octane, isooctane, cyclopentane, methylcyclopentane, cyclohexane, methylcyclohexane, benzene, toluene, xylene or ethylbenzene, a halogenated hydrocarbon such as methylene chloride, chloroform, carbon tetrachloride, bromoform, 1,2-dichloroethane, 1,1-dichloroethane, trichloroethane or tetrachloroethane, or an ether such as ethyl ether, isopropyl ether, ethyl butyl ether, butyl ether, dioxane, dimethyldioxane, tetrahydrofuran or tetrahydropyran.

In a case where such solvents are to be used, plural types of solvents may be used as mixed to adjust the solubility of the polysilazane or the evaporation rate of the solvent. The amount of the solvent varies depending upon the coating method to be employed and the structure or the average molecular weight of the polysilazane. However, it is preferably adjusted so that the solid content concentration of the coating fluid will be within a range of from 0.5 to 80 mass %.

Further, as the lubricity-imparting agent (C′) in the composition (Q′), the same compound as the lubricity-imparting agent (C) disclosed with respect to the composition (Q), is preferably used. Further, in the coating composition (Q′), the above-mentioned functional compounding agent may be incorporated, as the case requires. The thickness of the hard coat layer (X′) employing the coating composition (Q′) is preferably from 0.05 to 10 μm, particularly preferably from 0.1 to 3 μm. If the thickness of the hard coat layer (X1) is too thick, not only no further improvement of the surface property such as the scratch resistance can be expected, but also the layer tends to be brittle, and cracking or the like is likely to form even by a slight deformation of the disk. On the other hand, if it is too thin, no adequate abrasion resistance or scratch resistance based on the hard coat layer (X′) may be obtained.

Now, the optical disk substrate will be described.

The optical disk substrate may, for example, be a substrate having a guide groove directly formed on a glass or a transparent resin such as polycarbonate, polymethyl methacrylate or an amorphous polyolefin, or a substrate having a guide groove formed by a photopolymer method on a glass or the above-mentioned transparent resin.

On the surface of the guide groove of the above optical disk substrate, a laminated film comprising the following dielectric film, recording film, reflective film, etc., will be formed. The materials of the respective films are not particularly limited.

As the material for the dielectric film, for example, Si₃N₄, SiO₂, AlSiON, AlSiN, AlN, AlTiN, Ta₂O₅ or ZnS may, preferably, be mentioned.

The material for the recording film varies depending upon the recording system. For example, for a recordable optical recording medium, a chalcogenite type alloy of Te, Sn, Se, etc., may, for example, be mentioned; for a phase change type optical recording medium, a chalcogenite type alloy of TeOx, InSe, SnSb, etc., may, for example, be mentioned; and for a magnetooptical disk, an alloy of a transition metal and a rare earth metal, such as TbFeCo or NdDyFeCo (a single layer or an exchange coupling film of two or more layers) may preferably be mentioned.

The material for the reflective layer may, for example, preferably be a metal such as Al, Au, Ag or Cu, or an alloy such as Al—Ti or Al—Cr.

The optical disk of the present invention may, for example, be produced as follows.

On the surface of the above optical disk substrate having a guide groove, a laminated film (a recording layer) comprising a dielectric film, a recording film, a reflective film, etc., is formed by a usual method. The dielectric film, the recording film and the reflective film are respectively formed by a physical vapor deposition method such as sputtering or ion plating, or a chemical vapor deposition method such as plasma CVD.

In the present invention, a thin film cover layer (Z) is formed on the surface of a recording layer of an optical disk. As a method for forming the thin film cover layer (Z), a method in which a curable resin or the like is uniformly coated by a coating method such as a spin coating method, a roll coater method or a screen printing method, followed by curing by irradiation with an active energy ray such as a ultraviolet ray or an electron ray and/or thermal curing, or a method in which a resin film having a predetermined thickness is bonded via an adhesive layer, may, for example, be mentioned.

Such a thin film cover layer (Z) is not particularly limited, and a known or well known layer may be employed. For example, as the above-mentioned resin film having a predetermined thickness, a cast polycarbonate film may, for example, be mentioned. Otherwise, such a thin film cover layer (Z) may be formed by using a polyfunctional urethane (meth)acrylate compound as disclosed in paragraphs 0024 to 0036 in JP-A-11-240103 (hereinafter sometimes referred to as the compound (E)). As such a compound (E), particularly preferred is a bifunctional compound having a weight average molecular weight of at least 1500 and at most 20000. By using a bifunctional compound, the curing shrinkage at the time of photopolymerization can be reduced. Further, by employing the weight average molecular weight within the above range, the viscosity of the composition for forming the thin film cover layer can be adjusted within a desired range, and a layer of at least 50 μm can be formed by single coating, and the coating operation will be facilitated. The compound (E) may be used in a single type alone or in combination of two or more types.

The thin film cover layer (Z) in the present invention is preferably a cured product layer obtained by curing an active energy ray curable composition (P) which comprises a polyfunctional urethane (meth)acrylate compound (E), a compound (F) having at least one active energy ray curable polymerizable functional group having a polycycloalkane structure, and a photopolymerization initiator (D2).

In the proportions of the compound (E), the compound (F) having at least one active energy ray curable polymerizable functional group having a polycycloalkane structure (hereinafter sometimes referred to as the compound (F) or simply as (F)) and the photopolymerization initiator (D2) (hereinafter sometimes referred to simply as (D2)), in the composition (P), are not particularly limited. Usually, the compound (E) is preferably from 10 to 80 parts by mass, particularly preferably from 20 to 70 parts by mass, per 100 parts by mass of the total of (E), (F) and (D2). If the proportion of the compound (E) is within the above range, the viscosity of the composition (P) can be adjusted within the desired range, and a layer of at least 50 μm can be formed by single coating, and the coating operation will be facilitated.

It is important that the compound (F) in the present invention has a polycycloalkane structure. The polycycloalkane structure may, for example, be a bicycloalkane structure, a tricycloalkane structure, a tetracycloalkane structure or a pentacycloalkane structure. Usually, however, a bicycloalkane structure or a tricycloalkane structure is preferred.

The following compounds may, for example, be mentioned as such a compound (F).

Isobornyl (meth)acrylate, 8-(2-acryloyloxy)ethyloxycarbonyl-9-carboxytricyclo[5.2.1.0^{2,6}] decane, 3,4-bis(methacryloyloxy)tricyclo[5.2.1.0^{2,6}]decane, 3,4-bis(2-vinyl oxyethoxy)tricyclo[5.2.1.0^{2,6}]decane, 8,9-bis(acryloyloxymethyl)tricyclo[5.2.1.0^{2,6}]decane, 8-acryloyloxymethyl-9-hydroxymethyl-tricyclo[5.2.1.0^{2,6}]decane, 8-methacryloyloxy-methyl-9-hydroxymethyl-tricyclo[5.2.1.0^{2,6}] decane, 8,9-bis(methacryloyloxymethyl)tricyclo[5.2.1.0^{2,6}]decane, 8-hydroxymethyl-9-(2-vinyl oxyethoxymethyl)tricyclo[5.2.1.0^{2,6}]decane, 8,9-bis(2-vinyl oxyethoxymethyl)tricyclo[5.2.1.0^{2,6}]decane, 3,4-bis(methacryloyloxy)tricyclo[5.2.1.0^{2,6}]decane-8,9-dicarboxylic anhydride, 3,4-bis(methacryloyloxy)-8,9-bis(methoxycarbonyl)tricyclo[5.2.1.0^{2,6}]decane, 8,9-bis(allylcarbonyl)-3,4-epoxytricyclo[5.2.1.0^{2,6}]decane, 3(4)-hydroxy-4(3)-methacryloyloxytricyclo[5.2.1.0^{2,6}]decane, diallyltricyclo[5.2.1.0^{2,6}]decane-8,9-dicarboxylate, diallyloxyethyltricyclo[5.2.1.0^{2,6}]decane-8,9-dicarboxylate, and dimethyloltricyclo[5.2.1.0^{2,6}]decane diacrylate.

It is considered that in the present invention, by using the above compound (F), Tg of the composition (P) itself will be high, and the low curing shrinkage based on the polycycloalkane structure contributes to the development of the physical properties of the hard coat layer (X) or (X′) and to the low shrinkage of the thin film cover layer (Z) itself.

The proportion of the compound (F) in the composition (P) is not particularly limited. However, it is usually preferred that the compound (F) is from 20 to 70 parts by mass, particularly preferably from 30 to 60 parts by mass, per 100 parts by mass of the total of (E), (F) and (D2). If the proportion of the compound (F) is within this range, the viscosity of the composition (F) can be adjusted within the desired range, and a layer of 50 μm can be formed by single coating, and the coating operation will be facilitated. Further, if the proportion of the compound (F) is too much, the thin film cover layer (Z) tends to be too rigid to follow warping of the optical disk, and cracking or the like is likely to form.

As the polymerization initiator (D2), the same one as described as the polymerization initiator (D1) may preferably be mentioned. The proportion of the photopolymerization initiator (D2) in the composition (P) also is not particularly limited. Usually, the photopolymerization initiator (D2) is preferably from 0.01 to 20 parts by mass, particularly preferably from 0.1 to 10 parts by mass, per 100 parts by mass of the total of (E), (F) and (D2).

In the present invention, the composition (P) comprises preferably from 10 to 80 parts by mass, particularly preferably from 20 to 70 parts by mass, of (E), preferably from 20 to 70 parts by mass, particularly preferably from 30 to 60 parts by mass, of (F) and preferably from 0.01 to 20 parts by mass, particularly preferably from 0.1 to 10 parts by mass, of (D2), provided that the total of (E), (F) and (D2) is 100 parts by mass.

The composition (P) in the present invention may contain the above-mentioned mono-functional compound (G), etc., in addition to the above compound (E), the above compound (F) and the photopolymerization initiator (D2). Examples and the proportion of such a mono-functional compound may preferably be the same as mentioned above.

Further, as other additives, an epoxy resin, a polyamide, a polyimide, a polyurethane, a polybutadiene, a polychloroprene, a polyether, a polyester, a pentadiene derivative, a SBS (styrene/butadiene/styrene block copolymer), a hydrolyzed product of SBS, SIS (styrene/isoprene/styrene block copolymer), a petroleum resin, a xylene resin, a ketone resin, a fluorinated oligomer, a silicone type oligomer, a polysulfide type oligomer, etc., may be incorporated to the composition (P) in the present invention.

Further, as functional compounding agents other than the above photopolymerization initiator (D2), the functional compounding agents which may be incorporated to the above compound (Q), may, for example, be mentioned, and they may be optionally incorporated to the composition (P) in the present invention.

The thickness of the thin film cover layer (Z) is preferably from 50 to 150 μm. Further, with respect to the thickness of this layer, the desired value will be accurately determined from the optical design of the recording and retrieving device.

The method for forming the hard coat layer (X) or (X′) via the thin film cover layer (Z) on the surface of the recording layer of an optical disk, is not particularly limited, and a known or well-known method may be employed. For example, as a method for coating the composition (Q) or (Q′) on the thin film cover layer surface, various methods may be employed, such as a dipping method, a flow coating method, a spraying method, a bar coating method, a gravure coating method, a roll coating method, a blade coating method, an air knife coating method, a spin coating method, a slit coating method and a micro gravure coating method. Further, the same will apply in the case of coating the composition (P) for forming the thin film cover layer. For example, a plurality of coating methods may be combined such that the composition (P) is coated by gravure coating, and then the composition (Q) or (Q′) is coated by spin coating or spray coating. In the present invention, a spin coating method is preferably employed from the viewpoint of the productivity and the surface appearance.

Further, the active energy ray to be used for forming the hard coat layer (X) or (X′) by curing the composition (Q) or (Q′), is not particularly limited, and an ultraviolet ray, an electron ray or other active energy rays may be used. In the present invention, it is preferred to use an ultraviolet ray. As an ultraviolet ray source, a xenon lamp, a pulse xenon lamp, a low pressure mercury lamp, a high pressure mercury lamp, an ultrahigh pressure mercury lamp, a metal halide lamp, a carbon arc lamp, or a tungsten lamp may, for example, be used. Further, the same applies in a case where the thin film cover layer (Z) is to be formed.

In the present invention, in a case where the thin film cover layer (Z) is a cured product layer of the curable composition (P), the optical disk is prepared preferably as follows. On the surface of the recording layer formed on an optical disk substrate surface, a non-cured product layer (Z1), a partially cured product layer (Z2) or a cured product layer (Z) of the active energy ray curable composition (P) is formed, and on the surface of the (Z1), (Z2) or (Z), a non-cured product layer (X1) or a partially cured product layer (X2) of the active energy ray curable composition (Q) or the coating composition (Q′) is formed. Then, in a case where the layer of the above (P) is the cured product layer (Z), the non-cured product layer (X1) or the partially cured product layer (X2) of the above (Q) or (Q′) is cured, or in a case where the layer of the above (P) is the non-cured product layer (Z1) or the partially cured product layer (Z2), the layer of the above (P) and the layer of the above (Q) or (Q′) are simultaneously cured, to obtain an optical disk having the thin film cover layer (Z) and the hard coat layer (X) or (X′) formed.

Namely, in the above production process of the present invention, the timing for each of coating/curing of the composition (P) and coating/curing of the composition (Q) or (Q′) may be the timing of the following (1) to (4).

(1) On the surface of a recording layer formed on an optical disk substrate surface, the composition (P) is coated, and then irradiated with a sufficient amount of an active energy ray to sufficiently cure the layer of the composition (P) to form the cured product layer (Z) (the same as the thin film cover layer (Z)). Then, on the surface of the cured product layer (Z), the composition (Q) or (Q′) is coated and then irradiated with a sufficient amount of an active energy ray to sufficiently cure the composition (Q) or (Q′) to form the hard coat layer (X) or (X′). In such a case, two step curing may be employed such that the non-cured product layer (X1) of the composition (Q) or (Q′) is preliminarily converted to the partially cured layer (X2), and the partially cured layer (X2) is further cured. However, curing of the layer of the composition (Q) or (Q′) is usually preferably carried out by single step curing.

(2) On the surface of a recording layer formed on an optical disk surface, the composition (P) is coated to form a non-cured product layer (Z1) of the composition (P), and then, on the surface of the non-cured product layer (Z1), the composition (Q) or (Q′) is coated to form the non-cured product layer (Z1) of the composition (Q) or (Q′). Then, the composition (P) and the composition (Q) or (Q′) are simultaneously cured by irradiation with a sufficient amount of an active energy ray, to form the thin film cover layer (Z) and the hard coat layer (X). Also in this case, two step curing of the layer of the composition (Q) or (Q′) may be employed, but usually one step curing is preferred.

(3) On the surface of a recording layer formed on an optical substrate surface, the composition (P) is coated and then irradiated with an active energy ray of an amount (usually an irradiation amount up to about 500 mJ/cm²) to bring a dried state as felt by a finger and not to complete curing, to form the partially cured product layer (Z2) of the composition (P), and on the surface of the partially cured product layer (Z2), the composition (Q) or (Q′) is coated to form the non-cured product layer (X1) or the partially cured product layer (X2) of the composition (Q) or (Q′). Then, the composition (P) and the composition (Q) or (Q′) are simultaneously cured by irradiation with an active energy ray in a sufficient amount for complete curing, to form the thin film cover layer (Z) and the hard coat layer (X) or (X′). Also in this case, two step curing of the layer of the composition (Q) or (Q′) may be employed, but usually, one step curing is preferred.

(4) On the surface of a recording layer formed on an optical disk substrate surface, the composition (P) is coated to form the non-cured product layer (Z1) or the partially cured product layer (Z2) of the composition (P), and then, on the surface of the non-cured product layer (Z1) or the partially cured product layer (Z2), the composition (Q′) is coated to form the non-cured product layer (X1) of the composition (Q′). Then, firstly, the non-cured product layer (X1) is partially cured or completely cured to form the partially cured product layer (X2) or the completely cured product layer (X). Then, the non-cured product layer (Z1) or the partially cured product layer (Z2) is completely cured to form the thin film cover layer (Z) and the hard coat layer (X′). In such a case, at the time of coating the composition (Q′), the composition (P) is preferably a partially cured product layer (Z2). Further, at the time of completely curing the composition (P), the composition (Q′) is preferably a partially cured product layer (X2).

In the above methods (1) to (4), curing of the layer of the coating composition (Q′) may be carried out, for example, by a means of curing by exposure to a vapor atmosphere of a curing catalyst solution, or a means of curing under heating or at a normal temperature.

In the above-mentioned process of the present invention, in order to increase the interlaminer adhesion between the two cured product layers (Z) and (X) or (X′), it is preferred to adopt the timing of the above (2) or (3). Further, in the case where the above composition (P), (Q) or (Q′) contains a solvent, it is preferred to carry out curing after removing the solvent by drying after the coating.

The optical disk in the present invention may be a single plate or one having at least two sheets bonded to one another. Further, if necessary, a hub may be attached, or the optical disk may be assembled into a cartridge.

According to the present invention, it is possible to provide an optical disk having, on the laser beam incident side, a hard coat layer which has high abrasion resistance and high durability of the surface lubricity and which is excellent in transparency.

Further, according to the present invention, it is possible to provide an optical disk wherein the above thin film cover layer has a high transmittance for a laser beam and has good adhesion to the recording layer, and further a disk deformation due to shrinkage at the time of forming the thin film cover layer, is extremely small, and an adequate hard coat performance can be obtained when the specific hard coat layer is formed, and its production process.

### EXAMPLES

Now, the present invention will be described with reference to Preparation Examples (Examples 1 to 6 and 12), Working Examples (Examples 7 to 9, 13 and 14) and Comparative Examples (Examples 10 and 11), but it should be understood that the present invention is by no means restricted thereto.

In each Example, as an optical disk substrate, one having a laminated film (a reflective film made of Al, a first dielectric film made of SiN, a magnetooptical recording film made of TbFeCo and a second dielectric film made of SiN) formed on one side (the surface having a guide groove) of a polycarbonate substrate (diameter: 12 cm, thickness: 1.2 mm) for an optical recording medium, by a sputtering method, to form a recording layer, was employed. In Examples 7 to 11, one having a cast polycarbonate film (PURE-ACE, trade name, manufactured by Teijin Limited, thickness: 70 μm) as a thin film cover layer, bonded on the surface of the recording layer, via an adhesive layer (thickness: 28 μm), was used.

Further, measurement and evaluation of various physical properties with respect to samples obtained in the respective Examples, were carried out by the following methods, and their results are shown in Table 1. Here, as a sample for measuring the initial haze, the abrasion resistance and the 400 nm light transmittance, an optical disk substrate having formation of a reflective layer omitted, was employed.

Initial Haze and Abrasion Resistance

In accordance with the abrasion resistance test in JIS-R3212, two CS-10F abrasion rings were combined, respectively, with a weight of 500 g and rotated 500 times, whereby the haze was measured by a haze meter. The measurement of the haze was carried out at four positions on the abrasion cycle orbit, and an average value was calculated. The initial haze represents the value (%) of the haze before the abrasion resistance test, and the abrasion resistance represents the value (%) of (the haze after the abrasion resistance test)-(the haze before the abrasion resistance test).

400 nm Light Transmittance

By UV-3100, manufactured by Shimadzu Corporation, the light transmittance of a sample having the substrate cancelled, was measured at a measuring wavelength of 400 nm.

Adhesion

By an edge of a razor, eleven cut lines were imparted to a sample lengthwise and crosswise with spaces of 1 mm to form 100 crosscut sections, and a commercially available adhesive tape was intimately adhered and then rapidly pulled for peeling at an angle of 90°, whereby the number (m) of crosscut sections where the thin film cover layer and the hard coat layer remained without being peeled, is represented by m/100.

Sliding Resistance

By means of Slipping Tester HEIDON-14, manufactured by HEIDON COMPANY, the coefficient of dynamic friction was measured. Further, as an acceleration test for the sliding property, magnetic head RF320-74G, manufactured by Sony Corporation was brought in contact with a disk so that the load would be 2 g under environmental conditions of a temperature of 50±2° C. and a relative humidity of 50±5%, and the disk was continuously rotated at a rotational speed of 600 rpm for 5000000 times, whereby the coefficient of dynamic friction was measured before and after the rotational operation.

### Example 1

Into a 2000 mL four-necked flask equipped with a stirrer and a condenser, 1000 g of propylene glycol monomethyl ether acetate-dispersed type colloidal silica (silica content: 30 mass %, average particle size: 11 nm) and 50 g of 3-mercaptopropyltrimethoxysilane were added and stirred at 105° C. for 14 hours, followed by aging at room temperature for 10 hours, to obtain a mercapto silane-modified colloidal silica dispersion.

### Example 2

Into a 1000 mL four-necked flask equipped with a stirrer and a condenser, 184.60 g of dipentaerithritol hexaacrylate, 9.23 g of 2-methyl-1-[4-(methylthio)phenyl]-2-morpholinopropan-1-one, 0.72 g of silicone oil having both terminals of polymethylsiloxane modified with a methacryl group (X-22-164C, trade name, manufactured by Shin-Etsu Chemical Co., Ltd., number average molecular weight: 4800), 1.20 g of hydroquinone monomethyl ether and 345.90 g of methyl ethyl ketone were added and stirred for one hour at room temperature in a light shielding state for homogenization. Then, with stirring, 169.90 g of the mercapto silane-modified colloidal silica dispersion prepared in Example 1 was slowly added and further stirred for one hour at room temperature in a light shielding state for homogenization. Then, 86.5 g of 2-propanol was added, and the mixture was stirred for one hour at room temperature in a light shielding state, to obtain a coating liquid (Q1).

### Example 3

A coating liquid (Q2) was obtained with the same composition and by the same method as in Example 2 except that “X-22-164C” was changed to the same amount of silicone oil having both terminals of polydimethylsiloxane modified with a mercapto group (X-22-167B, trade name, manufactured by Shin-Etsu Chemical Co., Ltd., number average molecular weight: 3340).

### Example 4

A coating liquid (Q3) was obtained with the same composition and by the same method as in Example 2 except that “X-22-164C” was changed to the same amount of silicone oil having one terminal of polydimethylsiloxane modified with a methacryl group (FM0725, trade name, manufactured by Chisso Corporation, number average molecular weight: 10000).

### Example 5

A coating liquid (Q4) was obtained with the same composition and by the same method as in Example 2 except that “X-22-164C” was changed to the same amount of silicone oil having terminals of polydimethylsiloxane not modified (number average molecular weight 10000).

### Example 6

A coating liquid (Q5) was obtained with the same composition and by the same method as in Example 2 except that “X-22-164C” was not used.

### Example 7

On the surface of a recording layer of an optical disk substrate, the coating liquid (Q1) was coated (wet thickness: 6 μm) by a spin coating method and held for one minute in a hot air circulating oven of 90° C. to remove the solvent. Then, the obtained coating film was irradiated with an ultraviolet ray of 1000 mJ/cm² (an integrated energy amount of ultraviolet rays in a wavelength region of from 300 to 390 nm, the same applies hereinafter) by means of a high pressure mercury lamp in an air atmosphere, to form a transparent cured product layer having a thickness of 1.8 μm. Sample 1 was obtained wherein an adhesive layer/a thin film cover layer/a hard coat layer (total film thickness: 99.8 μm) were formed on the surface of the recording layer of the optical disk substrate.

### Example 8

Sample 2 was obtained in the same manner as in Example 7 except that in Example 7, the coating liquid (Q1) was changed to the coating liquid (Q2).

### Example 9

Sample 3 was obtained in the same manner as in Example 7 except that in Example 7, the coating liquid (Q1) was changed to the coating liquid (Q3).

### Example 10

Sample 4 was obtained in the same manner as in Example 7 except that in Example 7, the coating liquid (Q1) was changed to the coating liquid (Q4).

### Example 11

Sample 5 was obtained in the same manner as in Example 7 except that in Example 7, the coating liquid (Q1) was changed to the coating liquid (Q5).

### Example 12

Into a 1000 mL four-necked flask equipped with a stirrer and a condenser, 290.00 g of a bifunctional urethane acrylate-1 (UX-2201, trade name, manufactured by Nippon Kayaku Co., Ltd.), 170.00 g of a bifunctional urethane acrylate-2 (UX-8101, trade name, manufactured by Nippon Kayaku Co., Ltd.), 240.00 g of isobornyl acrylate, 100.00 g of dimethyloltricyclodecane diacrylate and 40.00 g of 1-hydroxycyclohexyl phenyl ketone were added and stirred for three hours at room temperature in a light shielding state to obtain a coating liquid (P1).

### Example 13

On the surface of a recording layer of an optical disk substrate, the coating liquid (P1) was coated (thickness: 98 μm) by a spin coating method, and the obtained coating layer (z1) was irradiated with an ultraviolet ray of 100 mJ/cm² (an integrated energy amount of ultraviolet rays in a wavelength region of from 300 to 390 nm, the same applies hereinafter) by means of a high pressure mercury lamp in an air atmosphere, to partially cure the coating layer (z1), to form a transparent partically cured product layer (Z2z1) having a thickness of 98 μm on the recording layer surface.

On the surface of the transparent partially cured product layer (Z2z1), the coating liquid (Q1) was coated (wet thickness: 6 μm) by a spin coating method and held for one minute in a hot air circulated oven of 90° C. to remove the solvent, thereby to form a coating film layer (x1), followed by irradiation with an ultraviolet ray of 1500 mJ/cm² by means of a high pressure mercury lamp in an air atmosphere to cure the coating film layer (x1) and the transparent partially cured product layer (Z2z1), to form a transparent cured product layer (Xx1) having a thickness of 1.8 μm and at the same time to form a transparent cured product layer (Zz1) having the transparent partially cured product layer (Z2z1) cured. Sample 6 was obtained wherein a thin film cover layer (Zz1)/a hard coat layer (Xx1) (total film thickness: 99.8 μm) was formed on the surface of the recording layer of the optical disk substrate.

### Example 14

In the same manner as in Example 13, a transparent partially cured product layer (Z2z1) having a thickness of 99 μm was formed on the surface of a recording layer of an optical disk substrate, by using the coating liquid (P1).

On the surface of the transparent partially cured product layer (Z2z1), a coating liquid prepared by adding 0.05 g of silicone oil having both terminals of polydimethylsiloxane modified with a methacryl group (X-22-164C, trade name, manufactured by Shin-Etsu Chemical Co., Ltd., number average molecular weight: 4800) to 100 g of a xylene solution of a low temperature curable perhydropolysilazane (solid content: 20 mass %, “N-L110”, trade name, manufactured by Clariant Japan K.K.), was coated (wet thickness: 6 μm) by a spin coating method and held for one minute in a hot air circulating oven of 90° C. to remove the solvent, thereby to form a coating film layer (x1), followed by irradiation with an ultraviolet ray of 1500 mJ/cm² by means of a high pressure mercury lamp in an air atmosphere, to cure the coating layer (x1) and the transparent partially cured product layer (Z2z1), to form a transparent cured product layer (Xx1) having a thickness of 1.2 μm and at the same time to form a transparent cured product layer (Zz1) having the transparent partially cured product layer (Z2z1) cured. Sample 7 was obtained wherein a thin film cover layer (Zz1)/a hard coat layer (Xx1) (total film thickness: 100.2 μm) was formed on the surface of the recording layer of the optical disk substrate.

TABLE 1

| | | | | | | Co- |
|---|---|---|---|---|---|---|
| | | | | | | effi- |
| | | | | 400 nm | | cient of |
| | | | | light | | dynamic |
| | | | | trans- | | friction |
| | | Initial | Abrasion | mit- | | (initial/ |
| | | haze | resist- | tance | Adhesion | after |
| Ex. | Sample | (%) | ance (%) | (%) | (m/100) | test) |
| 7 | 1 | 0.5 | 2.8 | 92.0 | 100 | 0.15/0.20 |
| 8 | 2 | 0.4 | 3.2 | 92.4 | 100 | 0.10/0.12 |
| 9 | 3 | 0.5 | 3.4 | 91.8 | 100 | 0.14/0.15 |
| 10 | 4 | 5 | 2.7 | 92.5 | 100 | 0.20/0.80 |
| 11 | 5 | 0.5 | 2.9 | 93.0 | 100 | 0.95/0.95 |
| 13 | 6 | 0.4 | 2.2 | 92.0 | 100 | 0.15/0.20 |
| 14 | 7 | 0.5 | 0.6 | 92.2 | 100 | 0.12/0.15 |

The entire disclosures of Japanese Patent Application No. 2001-374579 filed on Dec. 7, 2001, Japanese Patent Application No. 2001-383200 filed on Dec. 17, 2001 and Japanese Patent Application No. 2001-393245 filed on Dec. 26, 2001 including specifications, claims and summaries are incorporated herein by reference in their entireties.

What is claimed is:

1. An optical disk having a hard coat layer having lubricity imparted, which is an optical disk of a system wherein a recording layer is irradiated through a thin film cover layer with a light to be used for recording and/or retrieving, characterized in that on the surface of the recording layer formed on an optical disk substrate, the following hard coat layer (X) is formed via the thin film cover layer (Z):
Hard coat layer (X): A cured product layer obtained by curing an active energy ray curable composition (Q) which comprises a polyfunctional compound (A) having at least two polymerizable functional groups polymerizable by an active energy ray, a modified colloidal silica (B) having an average particle size of from 1 to 200 nm and having the surface modified with a mercapto silane compound having an organic group having a mercapto group, and a hydrolysable group and/or a hydroxyl group, bonded to a silicon atom, a lubricity-imparting agent (C) having a radical polymerizable functional group in its molecule, and a photopolymerization initiator (D1).

2. The optical disk according to claim 1, wherein the thin film cover layer (Z) is a cured product layer obtained by curing an active energy ray curable composition (P) which comprises a polyfunctional urethane acrylate compound (E), a compound (F) having at least one active energy ray curable polymerizable functional group having a polycycloalkane structure, and a photopolymerization initiator (D2).

3. The optical disk according to claim 1, wherein the active energy ray curable composition (Q) comprises 100 parts by mass of the polyfunctional compound (A), from 5 to 300 parts by mass of the modified colloidal silica (B), from 0.01 to 10 parts by mass of the lubricity-imparting agent (C), and from 0.1 to 20 parts by mass of the photopolymerization initiator (D1).

4. The optical disk according to claim 2, wherein the active energy ray curable composition (P) comprises from 10 to 80 parts by mass of (E), from 20 to 70 parts by mass of (F), and from 0.01 to 20 parts by mass of (D2), provided that the total of (E), (F) and (D2) is 100 parts by mass.

5. The optical disk according to claim 1, wherein the mercapto silane compound is a compound represented by the following formula (1):
HS—R—SiXₙR¹₃₋ₙ (1)
provided that in the formula (1), HS—R is an organic group having a mercapto group, R is a bivalent hydrocarbon group, R¹ is a monovalent hydrocarbon group, X is a hydroxyl group or a hydrolysable group, and n is an integer of from 1 to 3.

6. The optical disk according to claim 1, wherein the modified colloidal silica (B) is one obtained by adding a mercapto silane compound to an organic dispersant having a colloidal silica dispersed therein, followed by hydrolysis.

7. The optical disk according to claim 1, wherein the lubricity-imparting agent (C) has a number average molecular weight of at least 1000.

8. An optical disk having a hard coat layer having lubricity imparted, which is an optical disk of a system wherein a recording layer is irradiated through a thin film cover layer with a light to be used for recording and/or retrieving, characterized in that on the surface of the recording layer formed on an optical disk substrate, the following hard coat layer (X′) is formed via the thin film cover layer (Z):
Hard coat layer (X′): A cured product layer obtained by curing a coating composition (Q′) which comprises a polysilazane (H) and a lubricity-imparting agent (C′) having a radical polymerizable functional group in its molecule.

9. The optical disk according to claim 8, wherein the thin film cover layer (Z) is a cured product layer obtained by curing an active energy ray curable composition (P) which comprises a polyfunctional urethane acrylate compound (E), a compound (F) having at least one active energy ray curable polymerizable functional group having a polycycloalkane structure, and a photopolymerization initiator (D2).

10. The optical disk according to claim 9, wherein the active energy ray curable composition (P) comprises from 10 to 80 parts by mass of (E), from 20 to 70 parts by mass of (F), and from 0.01 to 20 parts by mass of (D2), provided that the total of (E), (F) and (D2) is 100 parts by mass.

11. The optical disk according to claim 8, wherein the lubricity-imparting agent (C′) has a number average molecular weight of at least 1000.

12. A process for producing an optical disk of a system wherein a recording layer is irradiated through a thin film cover layer with a light to be used for recording and/or retrieving, characterized by forming a non-cured product layer (Z1), a partially cured product layer (Z2) or a cured product layer (Z) of the active energy ray curable composition (P), on the surface of a recording layer formed on an optical disk substrate, forming a non-cured product layer (X1) or a partially cured product layer (X2) of the active energy ray curable composition (Q) or the coating composition (Q′), on the surface of said (Z1), (Z2) or (Z), and then, curing the non-cured product layer (X1) or the partially cured product layer (X2) of said (Q) or (Q′), when the layer of said (P) is the cured product layer (Z), or simultaneously curing the layer of said (P) and the layer of said (Q) or (Q′), when the layer of said (P) is the non-cured product layer (Z1) or the partially cured product layer (Z2), to obtain an optical disk having the thin film cover layer (Z) and the hard coat layer (X) or (X′) formed.
